(19) United States
(12) Patent Application Publication
(10) Pub. No.: US 2024/0239148 A1
(43) Pub. Date: Jul. 18, 2024

(54) Regenerative Shock Absorber

(71) Applicant: UNIVERSITY OF SOUTHAMPTON, Southampton (GB)

(72) Inventor: Mohamed Torbati, Southampton (GB)

(21) Appl. No.: 18/564,228

(22) PCT Filed: May 16, 2022
(86) PCT No.: PCT/EP2022/063197

§ 371 Date: Nov. 27, 2023

(30) Foreign Application Priority Data
May 28, 2021 (GB) 2107688.0
Mar. 30, 2022 (GB) 2204596.7

(51) Int. Cl. B60G 13/14; H02K 7/02; H02K 7/108; H02K 7/18

(52) U.S. Cl. CPC B60G 13/14; H02K 7/02; H02K 7/108; H02K 7/1853; B60G 2202/25; B60G 2206/41; B60G 2300/60; B60G 2800/162

(57) ABSTRACT

A regenerative shock absorber having an input module for receiving input linear vibration. A transmission mechanism having an output shaft, and configured to convert relative linear motion of opposite first and second end parts of the shock absorber into rotational motion of the output shaft. A generator module having a flywheel fitted to the output shaft, and an electromagnetic generator. The output shaft may comprise a self-reversing leadscrew which is rotated in a unidirectional direction of rotation when a clutch mechanism fitted thereto is translationally moved relative to the output shaft in each of opposite first and second linear directions. Alternatively, the output shaft may comprise a single threaded leadscrew. The electromagnetic generator is driven when a clutch mechanism fitted to the output shaft is translationally moved relative to the output shaft in one linear direction, and a second electromagnetic generator fitted to the clutch mechanism is driven when the clutch mechanism is translationally moved relative to the output shaft in the opposite linear direction.

The present invention relates to a regenerative shock absorber.

Shock absorbers have been conventionally used in vehicles for many years for providing a mechanical shock absorption functionality between a vehicle body and the axle of the vehicle. Recently, with the development of more energy efficient vehicles, and in particular electric or hybrid electric-internal combustion vehicles such as automobiles, regenerative shock absorbers have been developed. Regenerative shock absorbers are designed to generate an electrical power output when the shock absorber is compressed and expanded under varying loads, by scavenging or harvesting mechanical energy to generate electrical energy. The electrical power can be stored in a battery and/or used to power an electrical component in the vehicle.

One known regenerative shock absorber is disclosed in a paper entitled “A high-efficiency regenerative shock absorber considering twin ball screws transmissions for application in range-extended electric vehicles”, by Zhanwen Wang et al., published in Energy and Built Environment, Volume 1, Issue 1, 2020, pages 36-49 (available at: https://www.sciencedirect.com/science/article/pii/S266612331930008X).

In this design, the regenerative shock absorber comprises a transmission mechanism acting as a linkage between a suspension vibration input module and a generator module. A cylinder has opposite upper and lower end parts, and a middle part, which can be moved together under a compressive load. The reciprocating oscillations induced in the vibration input module are transmitted into the upper and middle cylinders. The transmission mechanism module converts the reciprocating linear vibration between the cylinder parts into unidirectional rotation of a generator shaft. The basic structure of the transmission mechanism module consists of two rods, a pair of parallel ball screws, having threads in opposite rotational directions, and respective screw nuts, a pair of overrun clutches, three gears, and a generator. The rods are immobilised between the top of the upper cylinder part and inside of the middle cylinder part, to deliver the vibration of the cylinders to the screw nuts. The clutches and gearing system allow reciprocal linear motion to produce unidirectional rotation that is then used to turn a generator. However, this regenerative shock absorber design suffers from the problem of excessive size and complexity, and requires a large space for implementation, reducing the versatility and effectiveness of the design.

Another known regenerative shock absorber is disclosed in a paper entitled “A high-efficiency energy regenerative shock absorber using helical gears for powering low-wattage electrical device of electric vehicles”, by Waleed Salman et al., published in Energy, Volume 159, 2018, pages 361-372 (available at: https://www.sciencedirect.com/science/article/pii/S0360544218312179?casa_token=fTnNO4 iFjngAAAAA:gc7q0J17N2UGs3rksi10DaoAVA_69MFkkEgNZLTRIPuBpiQloF2C3plj1S9a YGQ-K7Tpomso_A).

In this paper, a regenerative shock absorber is based on helical gears and dual tapered roller clutches. Two threads having opposite rotational directions are cut along a common shaft at opposite ends of the shaft, and meet at the middle of the threaded shaft. A respective screw nut surrounds each thread, and respective one-way bearings surround each of the screw nuts. The transmission module consists of helical gears and one-way clutches, and converts bi-directional shaft motion to unidirectional motion for a generator. The threaded shaft is attached directly to the linear input motion, while the screw nuts are fixed in place, which results in this design suffering from the problem that the overall assembly immediately becomes larger, with more space required for the threaded shaft to move into. Also, the design is complex and bulky because a number of parts and space are needed to transmit the rotation of the screw nut to the generator. Finally, the design of the regenerative shock absorber requires excessive added mass, which would lead to an increase in inertia, causing a decrease in the overall efficiency of the regenerative shock absorber.

CN203945935U discloses an energy regenerative suspension shock absorber for an automobile. The energy regenerative suspension shock absorber comprises an upper working cylinder, a lower working cylinder, an energy regenerative motor located at the inner top of the upper working cylinder, a large gear ring located below the energy regenerative motor and connected with the rotor of the motor through an engagement gear, an overrun clutch A with an outer-ring gear which is directly engaged with the large gear ring, an overrun clutch B with an outer-ring gear which is engaged with the large gear ring through a planetary gear and located below the overrun clutch A, a thrust bearing located below the overrun clutch B, and a ball screw structure located below the thrust bearing. The ball screw structure is composed of a ball screw and a ball nut: the ball nut is fixed at the upper end of the lower working cylinder; the lower end of the screw penetrates through the ball nut and stretches into the lower working cylinder, the upper end is located by the thrust bearing, and the top end sequentially penetrates through the thrust bearing and the two overrun clutches. This design has a large number of mechanical parts by requiring a planetary gear, which takes up space, and is complex in structure.

US-A-2011/298399 discloses a vehicle damper including an electromagnetic damper configured to generate a damping force with respect to a motion of a sprung portion and an unsprung portion toward each other and a motion thereof away from each other. The damper includes: an electromagnetic motor; a motion converting mechanism; and an external circuit which is disposed outside the electromagnetic motor and including a first connection passage and a second connection passage and which includes a battery-device connection circuit for connecting the motor and a battery device and a battery-device-connection-circuit-current adjuster configured to adjust an electric current that flows in the battery-device connection circuit, wherein the damper system further includes an external-circuit controller configured to control an electric current that flows in the electromagnetic motor by controlling the external circuit and configured to control a flow of an electric current between the battery device and the electromagnetic motor by controlling the battery-device-connection-circuit-current adjuster. This design is complex and bulky.

As can be seen from the description above of a number of known regenerative shock absorbers, the use of a leadscrew and nut pairing that can transfer linear motion to rotational motion was known in the art of regenerative shock absorbers. However, by using a conventional leadscrew the rotational output varies constantly with the linear direction of shock absorption, which means that known regenerative shock absorbers which can generate power from rotational motion caused by random linear motion alternating in opposite shock absorption directions tend to be mechanically complex and bulky.

Accordingly, there is a need for a regenerative shock absorber which can efficiently generate electrical power from random linear motion alternating in opposite shock absorption directions, and is mechanically simple and compact. In particular, there is a need for a regenerative shock absorber which can avoid the need for any complicated gearing mechanism, thereby increasing in-service reliability and decreasing maintenance costs.

There is a further need for a regenerative shock absorber which has a high level of efficiency in generating electrical power from random linear motion alternating in opposite shock absorption directions.

There is a still further need for a regenerative shock absorber which has a wide frequency bandwidth for efficiently generating electrical power from random linear motion alternating in opposite shock absorption directions.

There is a yet further need for a regenerative shock absorber which can harvest energy from a moving, vibrating vehicle whilst acting as a conventional shock absorber or damper.

For a regenerative shock absorber for use in a road vehicle such as an automotive application, the regenerative shock absorber must fulfil the dual task of a shock absorber and energy harvester and the key indicators will be the device performance as well as the ride comfort and road handling. Consequently there is a need in the art for a regenerative shock absorber which harvests energy, yet does not compromise the ride comfort and driveability of the vehicle.

Finally, there is a need in the art for a regenerative shock absorber which can replace a traditional shock absorber without the need to modify the vehicle suspension structure, thereby providing a shock absorber additionally providing a regenerative function, which is can be retrofitted into many current vehicles.

The present invention aims at least partially to overcome these problems of known regenerative shock absorbers, and meet these needs in the shock absorber art.

Accordingly, in a first aspect the present invention provides a regenerative shock absorber comprising:
an input module for receiving input linear vibration, the input module comprising an elongate body including a pair of opposite first and second end parts for fitting to respective movable parts of a vehicle, wherein the first and second end parts are relatively movable in opposite first and second linear directions, which extend along a length direction of the elongate body, to compress or expand the length of the elongate body;
a transmission mechanism comprising an output shaft, the transmission mechanism being fitted within the elongate body and configured to convert relative linear motion of the opposite first and second end parts into rotational motion of the output shaft, wherein at least a portion of the output shaft is a self-reversing leadscrew having an outer cylindrical surface including a pair of overlying first and second helical grooves having rotationally opposite helical directions, and the transmission mechanism further comprises a first clutch mechanism threadably engaging the first and second helical grooves and fitted to the first end part, wherein the first clutch mechanism is configured to rotate the output shaft in a unidirectional rotational motion when the first end part, and the first clutch mechanism fitted thereto, are translationally moved relative to the output shaft in each of the first and second linear directions; and
a generator module fitted within the elongate body, the generator module comprising a flywheel and an electromagnetic generator having a rotor rotationally coupled to the flywheel, wherein the flywheel is configured to be rotatably driven by the output shaft in the same rotational direction as the unidirectional rotational motion of the output shaft.

In a second aspect, the present invention provides a regenerative shock absorber comprising:
an input module for receiving input linear vibration, the input module comprising an elongate body including a pair of opposite first and second end parts for fitting to respective movable parts of a vehicle, wherein the first and second end parts are relatively movable in opposite first and second linear directions, which extend along a length direction of the elongate body, to compress or expand the length of the elongate body;
a transmission mechanism comprising an output shaft, the transmission mechanism being fitted within the elongate body and configured to convert relative linear motion of the opposite first and second end parts into rotational motion of the output shaft, wherein at least a portion of the output shaft is a single-threaded leadscrew having an outer cylindrical surface including a helical groove having a helical direction, and the transmission mechanism further comprises a first clutch mechanism threadably engaging the helical groove and fitted to the first end part, wherein the first clutch mechanism is configured to rotate the output shaft in a first rotational direction when the first end part, and the first clutch mechanism fitted thereto, are translationally moved relative to the output shaft in the first linear direction, and wherein when the first end part, and the first clutch mechanism fitted thereto, are translationally moved relative to the output shaft in the second linear direction, the first clutch mechanism applies no rotational force on the output shaft; and
a generator module fitted within the elongate body, the generator module comprising a flywheel and a first electromagnetic generator having a rotor rotationally coupled to the flywheel, wherein the flywheel is configured to be rotatably driven by the output shaft in the first rotational direction when the output shaft is rotated in the first rotational direction whereby the first electromagnetic generator is driven when the output shaft is rotated in the first rotational direction, and the generator module further comprising a second electromagnetic generator which is coupled to the first clutch mechanism, the second electromagnetic generator being configured to be driven by rotation of a part of the first clutch mechanism when the first end part, and the first clutch mechanism fitted thereto, are translationally moved relative to the output shaft in the second linear direction.

Preferred features are defined in the dependent claims.

The regenerative shock absorbers of the preferred embodiments of the present invention which incorporate a self-reversing leadscrew (otherwise known as a “diamond-thread” leadscrew) provide the technical effect that a body threadably coupled to the self-reversing leadscrew can automatically reverse its travel direction while retaining a constant given sense of relative rotation of the leadscrew. In other words, this mechanism can translate a random linear bi-directional vibration into a continuous unidirectional rotational motion. It is known to those skilled in the art that the term “leadscrew” encompasses a ball screw, which is a type of leadscrew. In this specification, the term “leadscrew” is intended to encompass a ball screw.

Accordingly, the regenerative shock absorber can efficiently generate electrical power from random linear motion alternating in opposite shock absorption directions, and can be mechanically simple and compact. The regenerative shock absorber can also have a high level of efficiency in generating electrical power from random linear motion alternating in opposite shock absorption directions.

The regenerative shock absorber can avoid the need for any complicated gearing mechanism, thereby increasing in-service reliability and decreasing maintenance costs.

In addition, the regenerative shock absorbers of the preferred embodiments of the present invention can incorporate a flywheel and/or a second electrical generator which exhibits a free-spinning function which can cause electrical power to continue to be generated even though the input random linear motion has reduced in amplitude or changed in direction. This can enhance the efficiency of generating electrical power from a given input of random linear motion alternating in opposite shock absorption directions.

The regenerative shock absorbers of the preferred embodiments of the present invention can be used in a wide variety of vehicles, including road, rail and marine vehicles, but have particular application in road vehicles such as automobiles, trucks, motorbikes, etc.

Embodiments of the present invention will now be described in more detail by way of example only with reference to the accompanying drawings, in which:

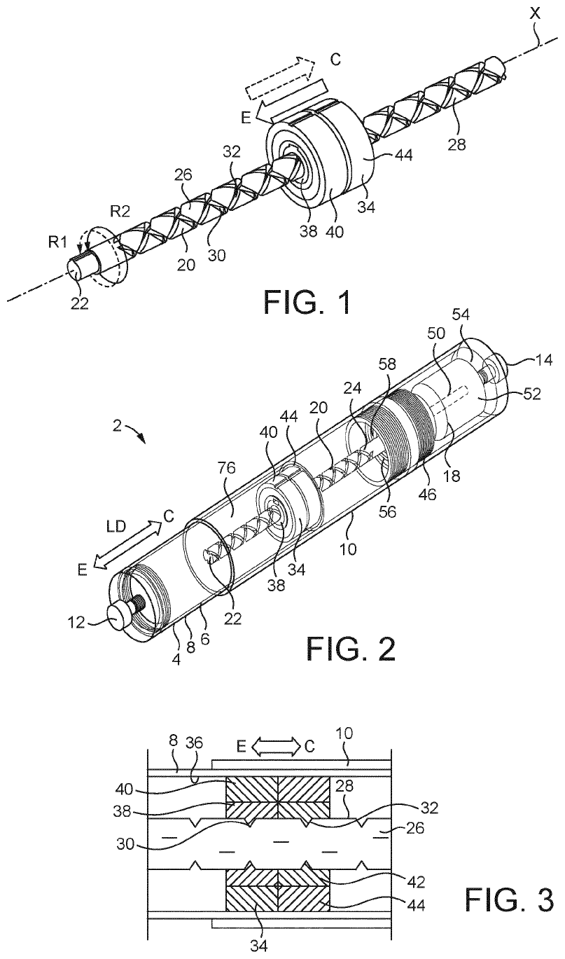

FIG. 1 is a schematic perspective view of a self-reversing leadscrew for use in a regenerative shock absorber in accordance with some embodiments of the present invention:

FIG. 2 is a schematic perspective view, partly in phantom, of a regenerative shock absorber in accordance with a first embodiment of the present invention, which includes the self-reversing leadscrew illustrated in FIG. 1:

FIG. 3 is an enlarged schematic cross-section through part of the self-reversing leadscrew in the embodiment of the regenerative shock absorber shown in FIG. 2:

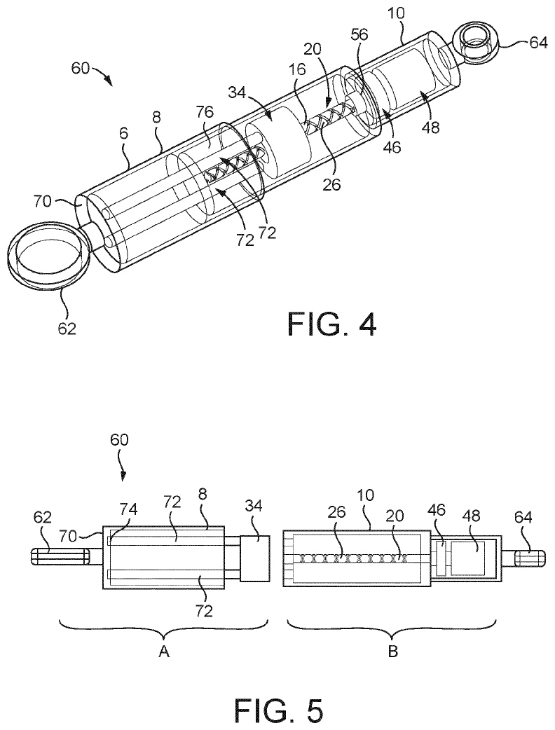

FIG. 4 is a schematic perspective view, partly in phantom, of a regenerative shock absorber in accordance with a second embodiment of the present invention, which includes the self-reversing leadscrew illustrated in FIG. 1:

FIG. 5 is a schematic exploded side view, partly in phantom, of the regenerative shock absorber illustrated in FIG. 4:

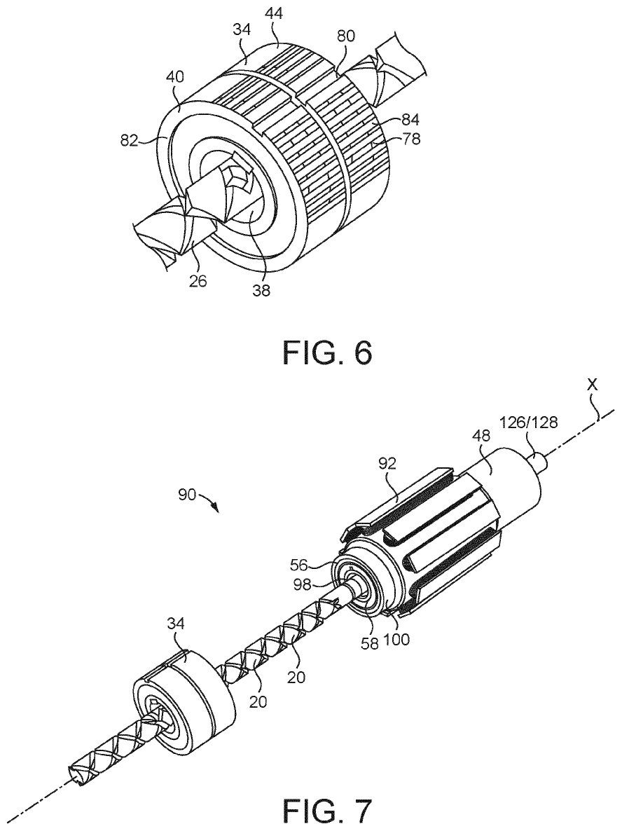

FIG. 6 is an enlarged perspective view of part of a modified self-reversing leadscrew which may be provided in any of the embodiments of the regenerative shock absorber in accordance with the present invention:

FIG. 7 is a schematic perspective view of the internal parts of a regenerative shock absorber in accordance with a third embodiment of the present invention, which includes the self-reversing leadscrew illustrated in FIG. 1:

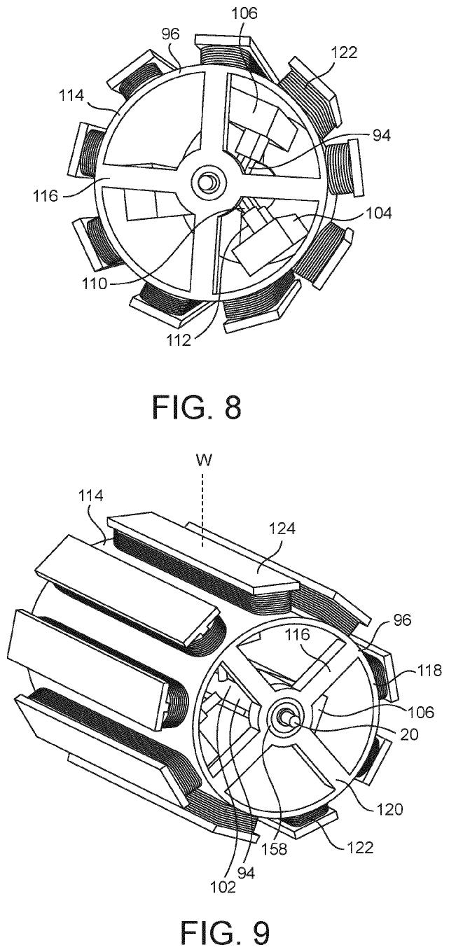

FIG. 8 is a schematic perspective view, from one end, of a flywheel which is provided in the regenerative shock absorber illustrated in FIG. 7:

FIG. 9 is a schematic perspective view, from one side, of the flywheel illustrated in FIG. 8:

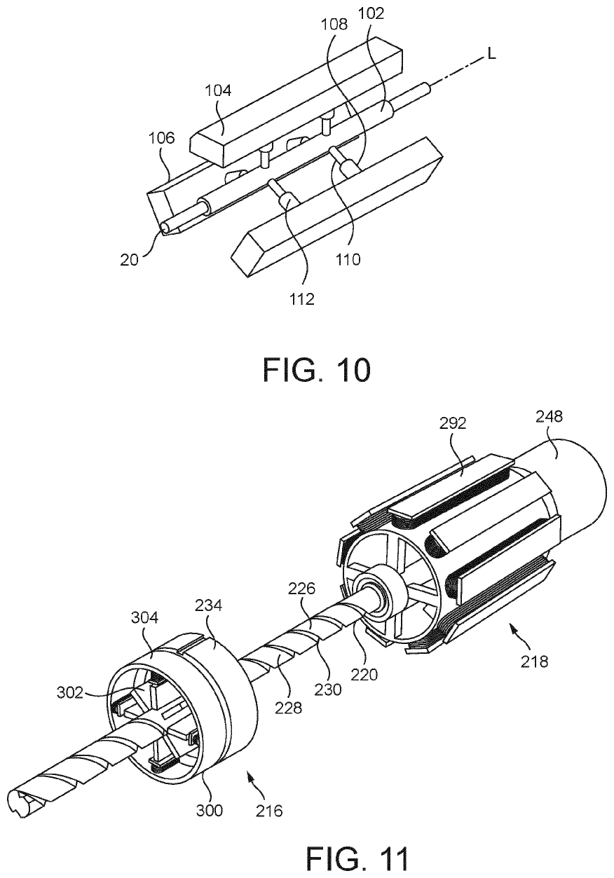

FIG. 10 is a schematic perspective view, from one side, of a permanent magnet assembly on a radially inner rotor part of the flywheel illustrated in FIG. 8:

FIG. 11 is a schematic perspective view of the internal parts of a regenerative shock absorber in accordance with a fourth embodiment of the present invention, which includes a single-threaded leadscrew:

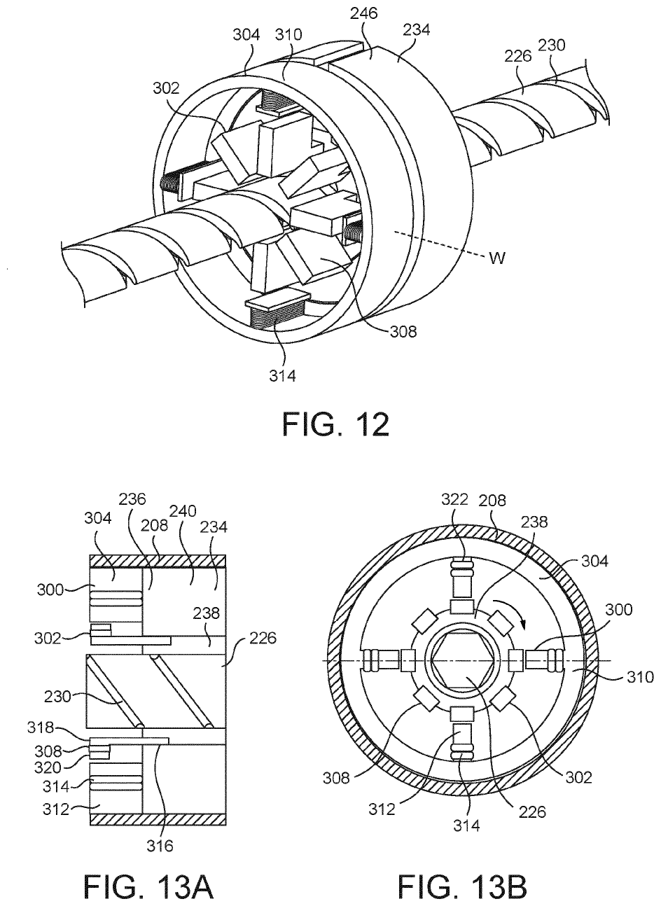

FIG. 12 is an enlarged perspective view of a second electrical generator and first clutch mechanism in the regenerative shock absorber illustrated in FIG. 11:

FIGS. 13(a) and 13(b) are, respectively, a schematic cross-sectional view and a schematic end view of the second electrical generator and first clutch mechanism illustrated in FIG. 12:

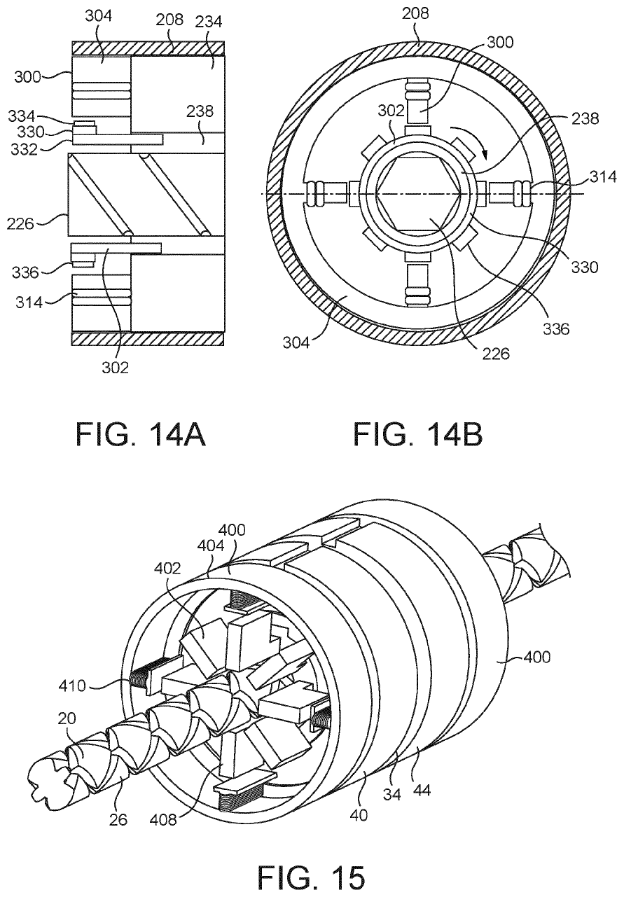

FIGS. 14(a) and 14(b) are, respectively, a schematic cross-sectional view and a schematic end view of a modified embodiment of the second electrical generator and first clutch mechanism illustrated in FIG. 12; and

FIG. 15 is a schematic perspective view of a further modified embodiment of the second electrical generator and first clutch mechanism illustrated in FIG. 12.

It is to be noted that some of the drawings are not to scale and some dimensions may be exaggerated for the purpose of clarity of illustration.

Referring to FIGS. 1 to 3, there is schematically illustrated a regenerative shock absorber 2 in accordance with a first embodiment of the present invention. FIG. 1 is highly schematic and shows the principle of operation of a self-reversing leadscrew in the embodiment of FIGS. 1 to 3, whereas FIG. 2 is a schematic perspective view of the regenerative shock absorber 2.

The regenerative shock absorber 2 comprises an input module 4 for receiving input linear vibration. The input module 4 comprises an elongate body 6 including a pair of opposite first and second end parts 8, 10 for fitting to respective movable parts of a vehicle (not shown). Each end part 8, 10 may be provide with a respective fitting element 12, 14 for attachment to the vehicle, for example for fitting between an axle and a chassis of a vehicle. The regenerative shock absorber 2 may be configured for use in any suitable vehicle which typically incorporates a shock absorber, for example a road vehicle such as an automobile, truck, motorbike, etc. The regenerative shock absorber 2 may also have application in some other vehicles, such as a railway vehicle or a marine vehicle, where some shock absorption may be required.

The first and second end parts 8, 10 are relatively movable in opposite first and second linear directions, indicated by letters C and E in FIGS. 1 and 2, which extend along a length direction LD of the elongate body, to compress or expand the length of the elongate body 6. In the illustrated embodiment, the first and second end parts 8, 10 of the elongate body 6 form a telescoping configuration in which the first end part 8 is slidably received within the second end part 10. However, the opposite configuration may be employed, and/or alternatively one or more additional telescoping parts may be provided between the opposite first and second end parts 8, 10.

The regenerative shock absorber further comprises a transmission mechanism 16 comprising an output shaft 20. The transmission mechanism 16 is fitted within the elongate body 6 and configured to convert relative linear motion of the opposite first and second end parts 8, 10 into rotational motion of the output shaft 20. A free end 22 of the output shaft 20 is oriented towards the first end part 8 and the opposite end 24 of the output shaft 20 is fitted to a generator module 18 as described later hereinbelow.

At least a portion of the output shaft 20 is a self-reversing leadscrew 26 having an outer cylindrical surface 28 including a pair of overlying first and second helical grooves 30, 32 having rotationally opposite helical directions. Such helical grooves 30, 32 form a “diamond-thread” pattern in the leadscrew surface 28. The transmission mechanism 16 further comprises a first clutch mechanism 34 threadably engaging the first and second helical grooves 30, 32.

An assembly of such a self-reversing leadscrew 26 and clutch mechanism 34 is known in the art. For example, it is known to provide a self-reversing leadscrew which is translationally fixed in position, and the leadscrew is rotated in a constant single rotational direction to drive a clutch mechanism backwards and forwards in opposite translational directions along the leadscrew; typically for depositing products from a product supply mounted on the clutch mechanism across the width of a production line.

In the present invention, the self-reversing leadscrew 26 is utilised to convert linear translational motion of the first clutch mechanism 34, in opposite translational directions along the leadscrew 26, into rotational motion of the output shaft 20.

As shown in FIG. 1, when the first clutch mechanism 34 is moved in direction C, shown by a hatched line, the self-reversing leadscrew 26 is rotated about longitudinal axis X in one rotational direction R1 also shown by a hatched line, whereas when the first clutch mechanism 34 is moved in the opposite direction E, shown by a solid line, in a reciprocating translational motion, the self-reversing leadscrew 26 is rotated in the same rotational direction R2 also shown by a solid line. Even though the translational directions C and E are opposite, the rotational directions R1 and R2 are the same.

In the illustrated embodiment, the first clutch mechanism 34 is fitted to the first end part 8 of the elongate body 6, although the opposite configuration may be employed in alternative embodiments. As shown in FIG. 3, in this embodiment the first clutch mechanism 34 is fitted to an internal tubular surface 36 of the first end part 34. Therefore when the first end part 8 is moved translationally, the first clutch mechanism 34 correspondingly moves with the first end part 8, and rotates the output shaft 20. The first clutch mechanism 34 is translationally fixed relative to the first end part 8. The fitting between the first clutch mechanism 34 and the first end part 8 prevents rotation of the entire first clutch mechanism 34 in the elongate body 6.

The first clutch mechanism 34 is configured to rotate the output shaft 20 in a unidirectional rotational motion when the first end part 8, and the first clutch mechanism 34 fitted thereto, are translationally moved relative to the output shaft 20 in each of the first and second linear directions C, E.

As shown in FIG. 3, which is a detailed cross-section through the first clutch mechanism 34, the first clutch mechanism 34 comprises a first helical screw element 38 threadably engaged with the first helical groove 30 and a first sprag clutch 40 fitted between the first helical screw element 38 and the first end part 8. A second helical screw element 42 is threadably engaged with the second helical groove 32, and a second sprag clutch 44 is fitted between the second helical screw element 42 and the first end part 8. The first and second helical screw elements 38, 42 have helical threads in opposite rotational directions, corresponding to the opposite rotational directions of the first and second helical grooves 30, 32.

Typically, the first and second helical screw elements 38, 42 are press-fitted inside the respective first and second sprag clutches 40, 44, so that the assembly is rotationally fixed. The first and second helical screw elements 38, 42 typically comprise helical threaded nuts which are threadably engaged with the respective threads 30, 32 in the self-reversing leadscrew 26 of the output shaft 20. However, other helical screw elements 38, 42 and other fittings between the helical screw elements 38, 42 and the sprag clutches 40, 44 may be employed.

In particular, in this embodiment of the present invention, the assembly of the first and second helical screw elements 38, 42, the threads 30, 32 in the self-reversing leadscrew 26 of the output shaft 20 and the sprag clutches 40, 44 may be modified to be in the form of a ball screw, in which a series of ball bearings is received in each respective helical thread 30, 32 instead of helical threaded nuts. In the modified embodiment, the helical threads 30, 32 function as a helical raceway for the ball bearings.

The first and second sprag clutches 40, 44 are fitted together, to form a single unified first clutch mechanism 34. Such sprag clutches 40, 44 are one-way free-spinning clutches which are known in the art. In one rotational direction the clutch is engaged, whereas in the opposite rotational direction the clutch is disengaged, and can freely spin.

The first and second sprag clutches 40, 44 are freely rotatable, relative to the respective first and second helical grooves 30, 32, in respective opposite first and second rotational directions. The first and second sprag clutches 40, 44 are arranged respectively to engage the respective first or second helical groove 30, 32 by the respective first or second helical screw element 38, 42 and thereby rotate the self-reversing leadscrew 26 of the output shaft 20 in the unidirectional rotational motion when the first end part 8 is translationally moved relative to the output shaft 20 in a respective one of the first or second linear directions C, E.

In other words, when the first clutch mechanism 34 is moved in direction C, one of the first and second sprag clutches 40, 44 is engaged with the respective first or second helical screw element 38, 42 to cause the output shaft 20 to be rotated in the unidirectional direction of rotation. The other of the first and second sprag clutches 40, 44 is disengaged from the respective first or second helical screw element 38, 42, and allows the respective first or second helical screw element 38, 42 to freely slide in the respective first or second helical groove 30, 32.

In contrast, when the first clutch mechanism 34 is moved in the opposite direction E, the other of the first and second sprag clutches 40, 44 is engaged with the respective first or second helical screw element 38, 42 to cause the output shaft 20 to be rotated in the same unidirectional direction of rotation. The first-mentioned first or second sprag clutch 40, 44 is disengaged from the respective first or second helical screw element 38, 42, and allows the respective first or second helical screw element 38, 42 to freely slide in the respective first or second helical groove 30, 32.

Accordingly, compression or expansion of the regenerative shock absorber 2 causes the output shaft 20 to be rotated in the same unidirectional direction of rotation.

As shown in FIG. 2, a generator module 18 is fitted within the elongate body 6. The generator module 18 comprises a flywheel 46 and an electromagnetic generator 48 having a rotor 50 (illustrated by dashed lines in FIG. 2) rotationally coupled to the flywheel 46. Preferably, the electromagnetic generator 48 is a DC brushless motor, which has compact dimensions and a low rotor inertia.

In the illustrated embodiment, an outer housing 52 of the electromagnetic generator 48 is fitted to an internal surface 54 of the second end part 10 of the elongate body 6.

The electrical power output from the electromagnetic generator 48 can be used to charge a power storage unit (not shown) such as a battery or a supercapacitor, and/or can be used to provide a real-time power supply to an electrical component of the vehicle.

The flywheel 46 is configured to be rotatably driven by the output shaft 20 in the same rotational direction as the unidirectional rotational motion of the output shaft 20.

The generator module 18 further comprises a second clutch mechanism 56, typically a sprag clutch 58, which is fitted between the output shaft 20 and the flywheel 46. Typically, the end 24 of the output shaft 20, which is unthreaded, is fitted to a radially inner, input side of the second clutch mechanism 56, and a radially outer, output side of the second clutch mechanism is fitted to the flywheel.

The second clutch mechanism 56 is arranged to engage the flywheel 46 to cause rotation of the flywheel 46 in the same rotational direction as the unidirectional rotational motion when a rotational velocity of the output shaft 20 is at least a rotational velocity of the flywheel 46. In contrast, when a rotational velocity of the output shaft 20 is lower than the rotational velocity of the flywheel 46, the second clutch mechanism 56 disengages the flywheel 46 to enable free-spinning rotation of the flywheel 46 in the same rotational direction as the unidirectional rotational motion.

Consequently, in operation the regenerative shock absorber 2 is dynamically compressed and expanded, to provide ride comfort and improved vehicle handling. The regenerative shock absorber 2 can provide a continuous electrical power output of harvested energy from the moving vehicle.

Each compression or expansion causes the first clutch mechanism 34, which is fitted to the first end part 8, to be translationally moved relative to the second end part 10, with the movement being in compression direction C or expansion direction E. Each movement, in either direction, causes the output shaft 20, which is translationally fixed relative to the second end part 10, to be rotated in the unidirectional direction of rotation. The rotating output shaft 20 correspondingly rotates the flywheel 46, which rotates in the same unidirectional direction of rotation. If the rotational velocity of the output shaft 20 decreases, as a result of a reduction in the translational motion of the first clutch mechanism 34, for example by a vehicle transitioning from travelling over a rough road surface to travelling over a smoother road surface, then the flywheel 46 continues to rotate by a free-spinning action as a result of disengagement by the second clutch mechanism 56.

In use, the reciprocating nature of the translational input to the first clutch mechanism 34 means that the rectified rotational motion of the self-reversing screw 26 looks like a half sinusoidal wave, i.e., it goes from zero to a maximum speed and then back to zero. The flywheel 46 stores the input kinetic energy and when the input velocity falls down to zero, the flywheel 46 will continue to rotate. Hence, the sprag clutch 58 of the second clutch mechanism 56 prevents this stored kinetic energy from returning to the source, and the stored kinetic energy is used instead to drive the electromagnetic generator 48 and harvest energy.

It is to be noted that in order to achieve a given vehicle dynamics, the absolute and relative dimensions of the components of the regenerative shock absorber 2 may be suitably selected, as known to those skilled in the art. For example, it is possible to select appropriate parameters such as leadscrew length, leadscrew diameter, thread depth, etc. to provide appropriate mechanical in-service properties for the regenerative shock absorber 2 for use in any given vehicle.

A second embodiment of a regenerative shock absorber 60 in accordance with the present invention is illustrated in FIGS. 4 and 5. This embodiment is similar to the first embodiment and like parts are numbered with like reference numerals.

This embodiment is shown in assembled form in FIG. 4 and in disassembled from, as an exploded view, in FIG. 5, with FIG. 5 showing part A including the first end part 6 and the components fitted thereto and part A including the second end part 8 and the components fitted thereto. In the assembled form the second end part 8 is received within the first end part 6 by a telescoping configuration.

In the second embodiment, the first and second end parts 6, 8 have opposite fitting rings 62, 64 for fitting the regenerative shock absorber 60 between the axle and chassis of a vehicle. The output shaft 20, first clutch mechanism 34, flywheel 46 and generator 48 have the same structure as in the first embodiment (although the flywheel is illustrated differently in the two embodiments).

In this embodiment, the first clutch mechanism 34 is fitted to a free end 70 of the first end part 8 of the elongate body 6 by a plurality of elongate rods 72 which have one end 74 fitted to the free end 70 and an opposite end 76 fitted to the first clutch mechanism 34. These rods 72 translationally fix the first clutch mechanism 34 relative to the first end part 8, and also prevent rotation of the entire first clutch mechanism 34 in the elongate body 34.

FIG. 6 shows a modification of a regenerative shock absorber in accordance with the present invention. This modification may be incorporated into any of the embodiments described herein, to provide a third embodiment a regenerative shock absorber in accordance with the present invention.

In the third embodiment, as shown in FIGS. 2 and 4 for example, the elongate body defines an elongate internal chamber 76 in which the transmission mechanism 16 is located. A hydraulic fluid (not shown) fills the internal chamber 76 for hydraulically damping the linear translational motion of the first clutch mechanism 34 along the internal chamber 76. By filling the internal chamber 76 with a viscous hydraulic fluid, the damping properties of the regenerative shock absorber can be modified, and can be made to resemble the damping properties of a conventional hydraulic shock absorber.

As shown in FIG. 6, an outer circumferential surface 78 of the first clutch mechanism 34 comprises a plurality of elongate fluid flow channels 80 extending between opposite sides 82, 84 of the first clutch mechanism 34. These fluid flow channels 80 enable flow of the hydraulic fluid across the first clutch mechanism 34 between opposite portions of the internal chamber 76 on the opposite sides 82, 84 of the first clutch mechanism 34. This fluid flow provides a hydraulic damping function for the compression and expansion of the regenerative shock absorber by movement of the first clutch mechanism 34 along the output shaft 20. The fluid flow rate between the opposite portions of the internal chamber 76, and hence the damping properties, can be adjusted by modifying the dimensions and the number of the channels 80.

In addition, in any of the embodiments of the present invention, optionally a helical coil spring (not shown) may be fitted, in compression, around the regenerative shock absorber. Such a coil spring can provide that the shock absorber exhibits a natural frequency that is determined by the spring stiffness constant and the total mass of the regenerative shock absorber, which is given by the total mass and the inertance due to the moment of inertia of the rotating parts. The natural frequency affects the efficiency of the energy harvester function of the regenerative shock absorber during any given in-service application.

Such an energy harvester function will generate maximum power when the excitation frequency matches the natural frequency (i.e. resonance) of the regenerative shock absorber. In the case of a narrowband excitation, the spring and mass can be selected expressly to maximise harvesting efficiency. In particular, the mass can be varied to increase the operational bandwidth of the energy harvester function of the regenerative shock absorber.

A fourth embodiment of a regenerative shock absorber in accordance with the present invention is illustrated in FIGS. 7 to 10. The fourth embodiment shows a modification of a regenerative shock absorber which may be incorporated into any of the embodiments described herein. In many aspects this embodiment is similar to the first and second embodiments and like parts are numbered with like reference numerals.

The regenerative shock absorber 90 of the fourth embodiment has a modified flywheel 92 as compared to the previously described embodiments. The flywheel 92 is configured to function as a further electromagnetic generator.

As for the previous embodiments, an input side 98 of a third sprag clutch 58 as a second clutch mechanism 56, is fitted to the output shaft 20 and the output side 100 of the third sprag clutch 58 is fitted to the rotatable component of the flywheel 92.

The flywheel 92 comprises a radially inner rotor part 94 and a radially outer stator part 96 coupled to the radially inner rotor part 94. The rotatable component of the flywheel 92 includes the radially inner rotor part 94. The radially inner rotor part 94 includes a central portion 102 which is mounted for rotation, for example using one or more bearings 158, about a longitudinal axis X aligned with the longitudinal direction of the output shaft 20. The central portion 102 is connected to the output shaft 20, and rotates therewith. The radially inner rotor part 94 further includes an outer portion 104 which is attached to the central portion 102. The outer portion 104 is fixed in a radial direction, relative to the central portion 102.

In the illustrated embodiment, the outer portion 104 comprises an annular array of a plurality of permanent magnets 106 around the longitudinal axis. In the embodiment there are three permanent magnets 106 separated from each other by an angle of 120 degrees; however, fewer or more permanent magnets 106 may be provided. Each permanent magnet 106 has the shape of a rectangular block, with a length direction extending parallel to the longitudinal axis X although other shapes may be used. Each permanent magnet 106 is attached to the central portion 102 by a fixture mechanism 108. The fixture mechanism 108 is configured such that each permanent magnet 106 is fixed in a radial direction, relative to the central portion 102.

Each fixture mechanism 108 comprises at least one radial pin 110 extending from one of the central portion 102, as illustrated, or alternatively the permanent magnet 106. In the illustrated embodiment, for each permanent magnet 106 there are two radial pins 110, separated along the longitudinal axis, extending radially outwardly from the central portion 102. Alternatively, fewer or more pins 110 may be provided for each permanent magnet 106. At least one radial socket 112 extends from the other of the permanent magnet 106, as illustrated, or alternatively the central portion 102. In the illustrated embodiment, two radial sockets 112 extend radially inwardly from each permanent magnet 106. Each radial pin 110 is fixedly received in a respective radial socket 112.

The radially outer stator part 96 comprises a tubular part 114 disposed around the radially inner rotor part 94. A pair of radial connectors 116 couple the stator part 96 to the rotor part 94. In the illustrated embodiment, each radial connector 116 is located at a respective longitudinal end 118 of the tubular part 114. Furthermore, in the illustrated embodiment, each radial connector 116 comprises four radial arms 120, separated from each other by an angle of 90 degrees: however, fewer or more radial arms 120 may be provided.

The tubular part 114 further comprises a plurality of wound coils 122 of electrically conductive material. In the illustrated embodiment, the coils 122 are provided on an outer circumferential side of the tubular part 114. Alternatively, the coils 122 may be provided on an inner circumferential side of the tubular part 114. In the illustrated embodiment, there are nine wound coils 122 mutually separated around the tubular part 114: however, fewer or more wound coils 122 may be provided.

Each wound coil 122 has a winding axis W, which is aligned with a radius of the flywheel 92. The wound coil 122 has an elongate shape in an elongate length direction, in a plane of the wound coil 122, with the length direction being parallel to the longitudinal axis X. Typically, each coil 122 is wound around a core 124. The core 124 may be integral with, or separate from, the tubular part 114. In a preferred embodiment, the core 124 is a magnetic core, for example composed of a ferromagnetic material.

In this embodiment, the radially inner rotor part 94 and the radially outer stator part 96 are coupled together so that the rotor part 94 and the stator part 96 are relatively rotatable. In other words, the permanent magnets 106 are rotationally movable relative to the wound coils 122. The radially outer stator part 96 is rotationally fixed in position.

In this embodiment, only the radially inner rotor part 94, including the permanent magnets 106, constitutes the rotatable flywheel 92. The radially outer stator part 96 and the wound coils 122 thereon are fixed.

Furthermore, in this embodiment the generator module of the regenerative shock absorber 92 further comprises an electrical power take-off system, schematically shown by box 128 in FIG. 7, electrically connected to the wound coils 122 of electrically conductive material. The electrical power take-off system 128 is configured to conduct electrical current induced in the coils 122 by relative rotation of the permanent magnets 106 of the radially inner part 94 and the wound coils 122 of the radially outer part 96. The wound coils 122 of the flywheel 92 therefore can act as an auxiliary electromagnetic generator.

A fifth embodiment of a regenerative shock absorber in accordance with the present invention is illustrated in FIGS. 11 to 14.

In this embodiment, the regenerative shock absorber comprises an input module, which in use receives input linear vibration, as described hereinabove for the previous embodiments. The input module comprises an elongate body, which is not shown in FIGS. 11 to 14, but has any structure of the previous embodiments. As described hereinbefore, the elongate body includes a pair of opposite first and second end parts for fitting to respective movable parts of a vehicle. The first and second end parts are relatively movable in opposite first and second linear directions, which extend along a length direction of the elongate body, to compress or expand the length of the elongate body.

In this embodiment, the transmission mechanism 216 and the generator module 218 are modified as compared to the previous embodiments.

The transmission mechanism 216 comprises an output shaft 220. The transmission mechanism 216 is fitted within the elongate body and configured to convert relative linear motion of the opposite first and second end parts (not shown but as described earlier) into rotational motion of the output shaft 220.

At least a portion of the output shaft 220 is a single-threaded leadscrew 226 having an outer cylindrical surface 228 including a helical groove 230 having a helical direction.

The transmission mechanism 216 further comprises a first clutch mechanism 234 threadably engaging the helical groove 230. Typically, the first clutch mechanism 234 comprises a first helical screw element 238 threadably engaged with the helical groove 230, and a first sprag clutch 240 fitted between the first helical screw element 238 and the first end part 208. The first clutch mechanism 234 is fitted to the first end part 208 by either of the fittings shown in the first and second embodiments.

The helical screw element 238 may comprise a helical threaded nut, or alternatively a ball screw is provided and a series of ball bearings is received in the helical groove 230, the helical groove 230 functioning as a helical raceway for the ball bearings.

The first clutch mechanism 234 is configured to rotate the output shaft 220 in a first rotational direction when the first end part 214, and the first clutch mechanism 234 fitted thereto, are translationally moved relative to the output shaft 220 in a first linear direction. In contrast, when the first end part, and the first clutch mechanism 234 fitted thereto, are translationally moved relative to the output shaft 220 in an opposite second linear direction, the first clutch mechanism 234 applies no rotational force on the output shaft 220.

A generator module 218 is fitted within the elongate body (not shown). As for the previous embodiments, the generator module 218 comprises a flywheel, which in the illustrated embodiment is a flywheel 292 having a further electromagnetic generator, as described hereinbefore, and a first electromagnetic generator 248 having a rotor rotationally coupled to the flywheel 292. In FIG. 11 the flywheel 292 has the same construction as described above for the embodiment of FIGS. 7 to 10: alternatively, the flywheel may have the same construction as described above for the embodiments of FIGS. 1 to 5. Therefore the flywheel may be a flywheel as described above with reference to FIGS. 7 to 10, and comprise a further electromagnetic generator. Alternatively, the flywheel may be a passive flywheel, which does not independently generate electrical power, as described above with reference to FIGS. 2 to 5.

The flywheel 292 is configured to be rotatably driven by the output shaft 220 in the first rotational direction when the output shaft 220 is rotated in the first rotational direction whereby the first electromagnetic generator 248 is driven when the output shaft 220 is rotated in the first rotational direction.

The generator module 218 further comprises a second clutch mechanism 256 fitted between the output shaft 220 and the flywheel 292. The second clutch mechanism 256 is arranged to engage the flywheel 292 to cause rotation of the flywheel 292 in the same rotational direction as the first rotational direction when a rotational velocity of the output shaft 220 is at least a rotational velocity of the flywheel 292, and to disengage the flywheel 292 to enable free-spinning rotation of the flywheel 292 in the same rotational direction as the first rotational direction when a rotational velocity of the output shaft 220 is lower than the rotational velocity of the flywheel 292. Typically, the second clutch mechanism 256 comprises a third sprag clutch 258 fitted between the output shaft 220 and the flywheel 292.

Consequently, in operation the regenerative shock absorber is dynamically compressed and expanded, to provide ride comfort and improved vehicle handling.

Each compression or expansion causes the first clutch mechanism 234, which is fitted to the first end part 208, to be translationally moved relative to the second end part which is fixed to the vehicle, with the movement being in compression direction C or expansion direction E. When the first clutch mechanism 234 is moved in one direction the clutch is engaged and the clutch rotates the output shaft 220; whereas when the first clutch mechanism 234 is moved in the opposite direction the clutch is disengaged and the clutch does not cause rotation of the output shaft 220, and the first clutch mechanism 234 can slide along the output shaft 220 with the first helical screw element 238 freely rotating as a result of being driven by the helical groove 230 with which the first helical screw element 238 is threadably engaged.

In other words, in one movement direction the translationally moving clutch drives the output shaft 220 to rotate and drive the flywheel 292 which drives the generator 248, whereas in the opposite movement direction the non-rotating output shaft 220 (although there may be some residual rotation in the first rotational direction caused by the inertia of the flywheel 292 from a previous movement in the one movement direction) drives the first helical screw element 238 to rotate as the translationally moving clutch moves along the output shaft 220.

Therefore, in contrast to the embodiments incorporating a self-reversing leadscrew; for this embodiment incorporating a single-treaded leadscrew 226, only the movement of the first clutch mechanism 234 in one of the compression direction C or expansion direction E (typically for example in the compression direction C) causes the output shaft 220, which is translationally fixed relative to the second end part, to be rotated in the first rotational direction. The rotating output shaft 220 correspondingly rotates the flywheel 292, which rotates in the same first rotational direction. As for the previous embodiments, if the rotational velocity of the output shaft 220 decreases, then the flywheel 292 continues to rotate by a free-spinning action as a result of disengagement by the second clutch mechanism 256.

In this embodiment, the generator module 218 further comprises a second electromagnetic generator 300 which is coupled to the first clutch mechanism 234. The second electromagnetic generator 300 is configured to be driven by rotation of a part of the first clutch mechanism 234 when the first end part 208, and the first clutch mechanism 234 fitted thereto, are translationally moved relative to the output shaft 226 in the second linear direction.

The second electromagnetic generator 300 comprises a rotor part 302 and a stator part 304 respectively fitted to rotatable and non-rotatable parts of the first clutch mechanism 234. In particular, the rotor part 302 is fitted to the first helical screw element 238, which is threadably engaged with the helical groove 230. The stator part 304 is fitted to the radially outer part 236 of the first clutch mechanism 234 which is fitted to the first end part. The first clutch mechanism 234 is fitted to the first end part 208 by either of the fittings shown in the first and second embodiments.

Accordingly, when the first end part 208, and the first clutch mechanism 234 fitted thereto, are translationally moved relative to the output shaft 220 in the second linear direction, the rotor part 302 is rotated by the first clutch mechanism 234 relative to the stator part 304 in a second rotational direction opposite to the first rotational direction.

Referring in particular to FIGS. 13(a) and 13(b), in the second electromagnetic generator 300 the rotor part 302 comprises an annular array of permanent magnets 308. The stator part 304 comprises a tubular element 310 having a plurality of arms 312 which are oriented radially inwardly towards the rotor part 302. Each arm 312 supports a respective coil winding 314, to provide an annular array of coil windings 314 disposed annularly around the permanent magnets 308.

In the embodiment there are eight permanent magnets 308 separated from each other by an angle of 45 degrees: however, fewer or more permanent magnets 308 may be provided. Each permanent magnet 308 is elongate in shape and is fitted at one end 316 to the first helical screw element 238 so as to extend parallel to the longitudinal axis and along, but spaced from, the output shaft 220. At a free end 318 of each permanent magnet 308, an enlarged end part 320 extends radially outwardly towards, but spaced from, the array of coil windings 314.

In the embodiment there are four coil windings 314 separated from each other by an angle of 90 degrees: however, fewer or more coil windings 314 may be provided. Each coil winding 314 has a winding axis W, which is aligned with a radial direction of the stator part 304, and has an elongate shape in an elongate length direction, in a plane of the coil winding 314, the length direction being parallel to a rotational axis of the rotor part 302. Typically, each coil winding 314 is wound around a core 322. The core 322 may be integral with, or separate from, the arm 312 of the stator part 304. In a preferred embodiment, the core 322 is a magnetic core, for example composed of a ferromagnetic material.

As described above, when the first clutch mechanism 234 is moved in one translational movement direction, the clutch is disengaged and the non-rotating output shaft 220 drives the first helical screw element 238 to rotate as the translationally moving clutch moves along the output shaft 226, as shown by the arrow in FIG. 13(b). Consequently, the permanent magnets 308 of the second electromagnetic generator 300 are rotated relative to the coil windings, 314 which generates an electrical current in the second electromagnetic generator 300. An electrical power take-off system (not shown) is electrically connected to the coil windings 314 which is configured to conduct electrical current induced in the coil windings 314 by relative rotation of the permanent magnets 308 of the rotor part 302 and the coil windings 314 of the stator part 304.

Therefore, in contrast to the embodiments incorporating a self-reversing leadscrew, for this embodiment incorporating a single-treaded leadscrew 226, movement of the first clutch mechanism 234 in one of the compression direction C or expansion direction E (typically for example in the compression direction C) causes the output shaft 220 to be rotated in the first rotational direction to rotate the flywheel 292 to drive the first electromagnetic generator 248, and movement of the first clutch mechanism 234 in the opposite direction (typically for example in the expansion direction E) causes the rotor part 302 of the second electromagnetic generator 300 to be rotated in the opposite rotational direction to rotate the permanent magnets 308 of the second electromagnetic generator 300.

A modification to this embodiment is illustrated in FIGS. 14(a) and 14(b). In this modified embodiment, the second electromagnetic generator 300 additionally comprises a second sprag clutch 330 which is disposed between a radially inner portion 332 of the rotor part 302 and a radially outer portion 334 of the rotor part 302, the radially outer portion 334 comprising the annular array of permanent magnets 336. In this embodiment, as shown in FIG. 14(b), the radially inner portion 332 is annular and cylindrical in shape, and annularly surrounds the output shaft 226. The second sprag clutch 330 is also annular and cylindrical in shape, as shown in FIG. 14(b), and is externally mounted around the radially inner portion 332. The second sprag clutch 330 typically comprises a needle clutch.

The second sprag clutch 330 is arranged to engage the radially outer portion 334 of the rotor part 302 to cause rotation of the annular array of permanent magnets 336 in the second rotational direction when the radially inner portion 332 of the rotor part 302 is rotated in the second rotational direction. Therefore, when the rotor part 302 is rotated as described before, as shown by the arrow in FIG. 13(b) and also in FIG. 14(b), the second electromagnetic generator 300 generates electrical power by the driven rotation of the annular array of permanent magnets 336.

When the translational motion of the first helical screw element 238, which is threadably engaged with the helical groove 230, in the opposite direction is reduced or terminated, the rotational velocity of the first helical screw element 238 is correspondingly reduced, or becomes zero. This velocity reduction causes the second sprag clutch 330 to disengage the radially outer portion 334 of the rotor part 302 from the radially inner portion 332 of the rotor part 302. This disengagement in turn enables free-spinning rotation of the array of permanent magnets 336 in the second rotational direction when the radially inner portion 332 of the rotor part is not rotated in the second rotational direction.

In other words, the second sprag clutch 330 provides that when the first clutch mechanism 234 slows down or changes direction while the second electromagnetic generator 300 is generating electrical power, the second electromagnetic generator 300 can continue to generate electrical power because the second sprag clutch 330 permits the permanent magnets 336 to continue rotating under a free-spinning rotation. Since, as described hereinabove, the flywheel 292 is also fitted to the output shaft 220 by the second clutch mechanism 256, correspondingly when the output shaft rotation slows down while the first electromagnetic generator 248 is generating electrical power, the first electromagnetic generator 248 can continue to generate electrical power because the second clutch mechanism 256 permits the flywheel 292 to continue rotating under a free-spinning rotation.

A sixth embodiment of a regenerative shock absorber in accordance with the present invention is illustrated in FIG. 15.

This embodiment is a modification of the self-reversing leadscrew embodiments described above, and incorporates at least one second electromagnetic generator 400, and preferably a pair of second electromagnetic generators 400, coupled to the first clutch mechanism 34 in a manner similar to the second electromagnetic generator described above for the embodiment of FIGS. 11 to 13. Like parts are numbered with like reference numerals.

Each second electromagnetic generator 400 is configured to be driven by rotation of a part of the first clutch mechanism 34 when the first end part, and the first clutch mechanism 34 fitted thereto, are translationally moved relative to the output shaft 20 in a selected one of either the first linear direction or the second linear direction.

Each second electromagnetic generator 400 comprises a rotor part 402 and a stator part 404 respectively fitted to rotatable and non-rotatable parts of a respective first or second sprag clutch 40, 44 of the first clutch mechanism 34.

The rotor part 402 comprises an annular array of permanent magnets 408 and the stator part 404 comprises an annular array of a coil windings 410 disposed annularly around the permanent magnets 408. Each coil winding 410 has a winding axis, which is aligned with a radial direction of the stator part 404, and has an elongate shape in an elongate length direction, in a plane of the coil winding 410, the length direction being parallel to a rotational axis of the rotor part 402. As described above, the coil winding 410 is wound about a core 412, typically magnetic core.

When the first end part, and the first clutch mechanism 34 fitted thereto, are translationally moved relative to the output shaft 20 in the selected one of either the first linear direction or the second linear direction, the rotor part 402 is rotated by the first clutch mechanism 34 relative to the stator part 404 in a second rotational direction opposite to the first rotational direction to cause relative motion between the permanent magnets 408 and coil windings 410 on the rotor part 402 and the stator part 404.

Therefore each translational movement of the first clutch mechanism 34 causes a secondary generation of electrical power from a respective one of the second electromagnetic generators 400. The second electromagnetic generators 400 may added to the first clutch mechanism 34 of any of the embodiments of FIGS. 2 to 10, and an additional one of the second electromagnetic generators 400 may be added to the first clutch mechanism 234, on the opposite side from the generator 300, in the embodiments of FIGS. 11 to 14.

Various further alternative embodiments and modifications to the above-described embodiments will be apparent to those skilled in the art, and these are intended to be encompassed within the scope of the present invention as defined by the appended claims.

1. A regenerative shock absorber comprising:
an input module for receiving input linear vibration, the input module comprising an elongate body including a pair of opposite first and second end parts for fitting to respective movable parts of a vehicle, wherein the first and second end parts are relatively movable in opposite first and second linear directions, which extend along a length direction of the elongate body, to compress or expand the length of the elongate body;
a transmission mechanism comprising an output shaft, the transmission mechanism being fitted within the elongate body and configured to convert relative linear motion of the opposite first and second end parts into rotational motion of the output shaft, wherein at least a portion of the output shaft is a self-reversing leadscrew having an outer cylindrical surface including a pair of overlying first and second helical grooves having rotationally opposite helical directions, and the transmission mechanism further comprises a first clutch mechanism threadably engaging the first and second helical grooves and fitted to the first end part, wherein the first clutch mechanism is configured to rotate the output shaft in a unidirectional rotational motion when the first end part, and the first clutch mechanism fitted thereto, are translationally moved relative to the output shaft in each of the first and second linear directions; and
a generator module fitted within the elongate body, the generator module comprising a flywheel and an electromagnetic generator having a rotor rotationally coupled to the flywheel, wherein the flywheel is configured to be rotatably driven by the output shaft in the same rotational direction as the unidirectional rotational motion of the output shaft.

2. A regenerative shock absorber according to claim 1 wherein the first clutch mechanism comprises a first helical screw element threadably engaged with the first helical groove, a first sprag clutch fitted between the first helical screw element and the first end part, a second helical screw element threadably engaged with the second helical groove, and a second sprag clutch fitted between the second helical screw element and the first end part, wherein the first and second sprag clutches are freely rotatable, relative to the respective first and second helical grooves, in respective opposite first and second rotational directions, and the first and second sprag clutches are arranged respectively to engage the respective first or second helical groove by the respective first or second helical screw element and thereby rotate the output shaft in the unidirectional rotational motion when the first end part is translationally moved relative to the output shaft in a respective one of the first or second linear directions.

3. A regenerative shock absorber according to claim 1 wherein the generator module further comprises a second clutch mechanism fitted between the output shaft and the flywheel, wherein second clutch mechanism is arranged to engage the flywheel to cause rotation of the flywheel in the same rotational direction as the unidirectional rotational motion when a rotational velocity of the output shaft is at least a rotational velocity of the flywheel, and to disengage the flywheel to enable free-spinning rotation of the flywheel in the same rotational direction as the unidirectional rotational motion when a rotational velocity of the output shaft is lower than the rotational velocity of the flywheel.

4. A regenerative shock absorber according to claim 3 wherein the second clutch mechanism comprises a third sprag clutch fitted between the output shaft and the flywheel.

5. A regenerative shock absorber according to claim 1, wherein the generator module further comprises at least one second electromagnetic generator which is coupled to the first clutch mechanism, the second electromagnetic generator being configured to be driven by rotation of a part of the first clutch mechanism when the first end part, and the first clutch mechanism fitted thereto, are translationally moved relative to the output shaft in a selected one of either the first linear direction or the second linear direction.

6. A regenerative shock absorber according to claim 5 wherein the second electromagnetic generator comprises a rotor part and a stator part respectively fitted to rotatable and non-rotatable parts of the first clutch mechanism, the rotor part and the stator part having permanent magnets and coil windings thereon, wherein when the first end part, and the first clutch mechanism fitted thereto, are translationally moved relative to the output shaft in the selected one of either the first linear direction or the second linear direction, the rotor part is rotated by the first clutch mechanism relative to the stator part in a second rotational direction opposite to the first rotational direction to cause relative motion between the permanent magnets and coil windings on the rotor part and the stator part.

7. A regenerative shock absorber according to claim 6 wherein in the second electromagnetic generator the rotor part comprises an annular array of permanent magnets and the stator part comprises an annular array of a coil windings disposed annularly around the permanent magnets.

8. A regenerative shock absorber according to claim 5 wherein each coil winding has a winding axis, which is aligned with a radial direction of the stator part, and has an elongate shape in an elongate length direction, in a plane of the coil winding, the length direction being parallel to a rotational axis of the rotor part.

9. A regenerative shock absorber according to claim 5, and when appendant on claim 2, wherein the generator module comprises a pair of the second electromagnetic generators coupled to the first clutch mechanism, wherein each second electromagnetic generator is respectively coupled to the first sprag clutch or the second sprag clutch of the first clutch mechanism.

10. A regenerative shock absorber comprising:
an input module for receiving input linear vibration, the input module comprising an elongate body including a pair of opposite first and second end parts for fitting to respective movable parts of a vehicle, wherein the first and second end parts are relatively movable in opposite first and second linear directions, which extend along a length direction of the elongate body, to compress or expand the length of the elongate body;
a transmission mechanism comprising an output shaft, the transmission mechanism being fitted within the elongate body and configured to convert relative linear motion of the opposite first and second end parts into rotational motion of the output shaft, wherein at least a portion of the output shaft is a single-threaded leadscrew having an outer cylindrical surface including a helical groove having a helical direction, and the transmission mechanism further comprises a first clutch mechanism threadably engaging the helical groove and fitted to the first end part, wherein the first clutch mechanism is configured to rotate the output shaft in a first rotational direction when the first end part, and the first clutch mechanism fitted thereto, are translationally moved relative to the output shaft in the first linear direction, and wherein when the first end part, and the first clutch mechanism fitted thereto, are translationally moved relative to the output shaft in the second linear direction, the first clutch mechanism applies no rotational force on the output shaft;
a generator module fitted within the elongate body, the generator module comprising a flywheel and a first electromagnetic generator having a rotor rotationally coupled to the flywheel, wherein the flywheel is configured to be rotatably driven by the output shaft in the first rotational direction when the output shaft is rotated in the first rotational direction whereby the first electromagnetic generator is driven when the output shaft is rotated in the first rotational direction, and the generator module further comprising a second electromagnetic generator which is coupled to the first clutch mechanism, the second electromagnetic generator being configured to be driven by rotation of a part of the first clutch mechanism when the first end part, and the first clutch mechanism fitted thereto, are translationally moved relative to the output shaft in the second linear direction.

11. A regenerative shock absorber according to claim 10 wherein the second electromagnetic generator comprises a rotor part and a stator part respectively fitted to rotatable and non-rotatable parts of the first clutch mechanism, the rotor part and the stator part having permanent magnets and coil windings thereon, wherein when the first end part, and the first clutch mechanism fitted thereto, are translationally moved relative to the output shaft in the second linear direction, the rotor part is rotated by the first clutch mechanism relative to the stator part in a second rotational direction opposite to the first rotational direction to cause relative motion between the permanent magnets and coil windings on the rotor part and the stator part.

12. A regenerative shock absorber according to claim 11 wherein in the second electromagnetic generator the rotor part comprises an annular array of permanent magnets and the stator part comprises an annular array of a coil windings disposed annularly around the permanent magnets.

13. A regenerative shock absorber according to claim 12 wherein the second electromagnetic generator further comprises a second sprag clutch disposed between a radially inner portion of the rotor part and a radially outer portion of the rotor part which comprises the annular array of permanent magnets.

14. A regenerative shock absorber according to claim 13 wherein the second sprag clutch is arranged to engage the radially outer portion of the rotor part to cause rotation of the annular array of permanent magnets in the second rotational direction when the radially inner portion of the rotor part is rotated in the second rotational direction, and to disengage the radially outer portion of the rotor part to enable free-spinning rotation of the array of permanent magnets in the second rotational direction when the radially inner portion of the rotor part not rotated in the second rotational direction.

15. A regenerative shock absorber according to claim 12 wherein each coil winding has a winding axis, which is aligned with a radial direction of the stator part, and has an elongate shape in an elongate length direction, in a plane of the coil winding, the length direction being parallel to a rotational axis of the rotor part.

16. A regenerative shock absorber according to claim 10 wherein the first clutch mechanism comprises a first helical screw element threadably engaged with the helical groove, and a first sprag clutch fitted between the first helical screw element and the first end part.

17. A regenerative shock absorber according to claim 10 wherein the generator module further comprises a second clutch mechanism fitted between the output shaft and the flywheel, wherein second clutch mechanism is arranged to engage the flywheel to cause rotation of the flywheel in the same rotational direction as the first rotational direction when a rotational velocity of the output shaft is at least a rotational velocity of the flywheel, and to disengage the flywheel to enable free-spinning rotation of the flywheel in the same rotational direction as the first rotational direction when a rotational velocity of the output shaft is lower than the rotational velocity of the flywheel.

18. A regenerative shock absorber according to claim 17 wherein the second clutch mechanism comprises a third sprag clutch fitted between the output shaft and the flywheel.

19. A regenerative shock absorber according to claim 1 wherein the flywheel comprises a further electrical generator comprising a radially inner rotor part and a radially outer stator part, wherein the rotor part is mounted for rotation about a longitudinal axis aligned with the longitudinal direction of the output shaft, and is connected to the output shaft, and an annular array of a plurality of permanent magnets are attached to the rotor part around the longitudinal axis, wherein the stator part comprises a tubular part disposed around the rotor part, and the tubular part comprises a plurality of coils of electrically conductive material, wherein the rotor part and the stator part are relatively rotatable, and the stator part is rotationally fixed in position, wherein the further electrical generator is configured to induce electrical current in the coils by relative rotation of the permanent magnets of the rotor part and the coils of the stator part.

20. A regenerative shock absorber according to claim 19 wherein each coil has a winding axis, which is aligned with a radius of the flywheel, and has an elongate shape in an elongate length direction, in a plane of the coil, the length direction being parallel to the longitudinal axis.

21. A regenerative shock absorber according to claim 1 wherein the first clutch mechanism is fitted to an internal tubular surface of the first end part of the elongate body.

22. A regenerative shock absorber according to claim 1 wherein the first clutch mechanism is fitted to a free end of the first end part of the elongate body by a plurality of elongate rods which have one end fitted to the free end and an opposite end fitted to the first clutch mechanism.

23. A regenerative shock absorber according to claim 1 wherein an outer housing of the electromagnetic generator is fitted to an internal surface of the second end part of the elongate body.

24. A regenerative shock absorber according to claim 1 wherein the first and second end parts of the elongate body form a telescoping configuration in which one of the first and second end parts is slidably received within the other of the first and second end parts.

25. A regenerative shock absorber according to claim 1 wherein the first elongate body defines an elongate internal chamber in which the transmission mechanism is located, and a hydraulic fluid fills the internal chamber for hydraulically damping the linear translational motion of the first clutch mechanism along the internal chamber.

26. A regenerative shock absorber according to claim 25 wherein an outer circumferential surface of the first clutch mechanism comprises a plurality of elongate fluid flow channels extending between opposite sides of the first clutch mechanism to enable flow of the hydraulic fluid across the first clutch mechanism between opposite portions of the internal chamber on the opposite sides of the first clutch mechanism.
